(19) United States
(12) Patent Application Publication
(10) Pub. No.: US 2016/0013921 A1
(43) Pub. Date: Jan. 14, 2016

(54) RADIO BASE STATION, USER TERMINAL, RADIO COMMUNICATION SYSTEM AND RADIO COMMUNICATION METHOD

(71) Applicant: NTT DOCOMO, INC., Chiyoda-ku, Tokyo (JP)

(72) Inventors: Satoshi Nagata, Tokyo (JP); Chongning Na, Beijing (CN); Xiaolin Hou, Beijing (CN); Atsushi Harada, Beijing (CN)

(73) Assignee: NTT DOCOMO, INC., Tokyo (JP)

(21) Appl. No.: 14/772,397

(22) PCT Filed: Jan. 31, 2014
(86) PCT No.: PCT/JP2014/052300

§ 371 Date: Sep. 3, 2015

(30) Foreign Application Priority Data
Mar. 7, 2013 (JP) 2013-045804

(51) Int. Cl. H04L 5/00; H04W 72/04; H04J 11/00; H04L 5/14

(52) U.S. Cl. CPC H04L 5/0073; H04L 5/14; H04W 72/0446; H04L 5/0023; H04J 11/0056; H04W 72/0426

(57) ABSTRACT

To achieve traffic adaptation gain, while reducing inter-cell interference, a radio communication system in which TDD is used is disclosed. The radio communication system is one in which each radio base station in a cluster communicates with a user terminal by using a UL/DL configuration, and has a subset selection section that selects the subset to use in the cluster, from a plurality of subsets each of which includes a plurality of UL/DL configurations determined based on the number of fixed subframes, in which the transmission direction is fixed in the cluster, and a UL/DL configuration selection section that selects the UL/DL configuration to use to communicate with the user terminal, from a plurality of UL/DL configurations that are included in the selected subset.

### TECHNICAL FIELD

The present invention relates to a radio base station, a user terminal, a radio communication system and a radio communication method that are applicable to cellular systems and so on.

### BACKGROUND ART

Conventionally, as duplexing methods in radio communication systems, frequency division duplexing (FDD) to divide between the uplink (UL) and the downlink (DL) based on frequency and time division duplexing (TDD) to divide between the uplink and the downlink based on time have been known (for example, non-patent literature 1). In FDD, uplink signals and downlink signals are transmitted and received at the same time, in different frequencies. On the other hand, in TDD, uplink signals and downlink signals are transmitted and received in the same frequency, at different times.

Also, in radio communication systems to use TDD such as LTE (Long Term Evolution), frame configurations (UL/DL configurations), which represent the configurations (ratios) of uplink subframes and downlink subframes in a radio frame, are defined (see FIG. 1). For example, in FIG. 1, seven UL/DL configurations 0 to 6 to show the configurations of uplink subframes and downlink subframes are shown.

### CITATION LIST

### Non-Patent Literature

Non-Patent Literature 1: 3GPP, TR25.912 (V7.1.0), “Feasibility Study for Evolved UTRA and UTRAN,” September 2006

### SUMMARY OF INVENTION

### Technical Problem

Generally, traffic is asymmetrical between UL and DL. Also, the ratio of traffic between UL and DL in a given period is not constant, but varies over time or between locations. Consequently, in radio communication systems to use TDD, there is a demand to make effective use of radio resources by dynamically changing the UL/DL resource configuration in a given cell (transmission point, radio base station, etc.) depending on the variation of traffic. In particular, in small cells that are arranged in a macro cell, it is desirable to change the UL/DL resource configuration dynamically in order to achieve increased network capacity.

So, in future radio communication systems to use TDD such as LTE-advanced (LTE-A), which is a successor of LTE, a study is in progress to change between the UL/DL configurations shown in FIG. 1, on a per cell basis, in order to achieve traffic adaptation gain (dynamic TDD). Meanwhile, in dynamic TDD, when different transmission directions are assumed between neighboring cells (neighboring transmission points), there is a threat that interference is occurred between radio base stations or between user terminals (inter-cell interference).

The present invention has been made in view of the above, and it is therefore an object of the present invention to provide a radio base station, a user terminal, a radio communication system and a radio communication method that can achieve traffic adaptation gain, while reducing inter-cell interference, in a radio communication system using TDD.

### Solution to Problem

The radio communication system of the present invention is a radio communication system in which each radio base station in a cluster communicates with a user terminal by using a UL/DL configuration that represents a configuration of uplink subframes and downlink subframes in a radio frame, and which has a subset selection section that selects a subset to use in the cluster, from a plurality of subsets, each of which includes a plurality of UL/DL configurations determined based on the number of fixed subframes in which a transmission direction is fixed in the cluster, and a UL/DL configuration selection section that selects a UL/DL configuration to use to communicate with the user terminal, from a plurality of UL/DL configurations that are included in the selected subset.

### Advantageous Effects of Invention

According to the present invention, it is possible to achieve traffic adaptation gain, while reducing inter-cell interference, in a radio communication system using TDD.

### BRIEF DESCRIPTION OF DRAWINGS

FIG. 1 is a diagram to explain examples of UL/DL configurations;

FIG. 2 provides diagrams to explain inter-cell interference in dynamic TDD;

FIG. 3 is a diagram to explain half-duplex FDD;

FIG. 4 is a diagram to explain cell clustering;

FIG. 5 provides diagram to show examples of applying UL/DL configurations to cells in a cluster;

FIG. 6 is a diagram to show an example of applying UL/DL configurations to cells in a cluster according to the present invention;

FIG. 7 is a diagram to show examples of subsets used in the radio communication method of the present invention;

FIG. 8 provides diagrams to show examples of a subset 0 that is used in the radio communication method of the present invention;

FIG. 9 provides diagram to show examples of a subset 1 that is used in the radio communication method of the present invention;

FIG. 10 provides diagrams to show examples of a subset 2 that is used in the radio communication method of the present invention;

FIG. 11 provides diagrams to show examples of a subset 3 that is used in the radio communication method of the present invention;

FIG. 12 provides diagrams to show examples of assignment of fixed subframes and dynamic/restricted subframes in the radio communication method of the present invention;

FIG. 13 provides diagrams to show examples of assignment of fixed subframes and dynamic/restricted subframes in the radio communication method of the present invention;

FIG. 14 is a flowchart to show an overview of the operation of the radio communication method of the present invention;

FIG. 15 is a sequence diagram to show the operation of the radio communication method of the present invention in detail;

FIG. 16 is a flowchart to show the operation of cluster-level resource control in the radio communication method of the present invention;

FIG. 17 is a flowchart to show the operation of cell-level resource control in the radio communication method of the present invention;

FIG. 18 is a schematic diagram to show an example of a radio communication system according to the present embodiment;

FIG. 19 is a diagram to explain an overall structure of a radio base station according to the present embodiment;

FIG. 20 is a diagram to explain an overall structure of a user terminal according to the present embodiment;

FIG. 21 is a diagram to explain a functional structure of a radio base station according to the present embodiment; and

FIG. 22 is a diagram to explain a functional structure of a user terminal according to the present embodiment.

### DESCRIPTION OF EMBODIMENTS

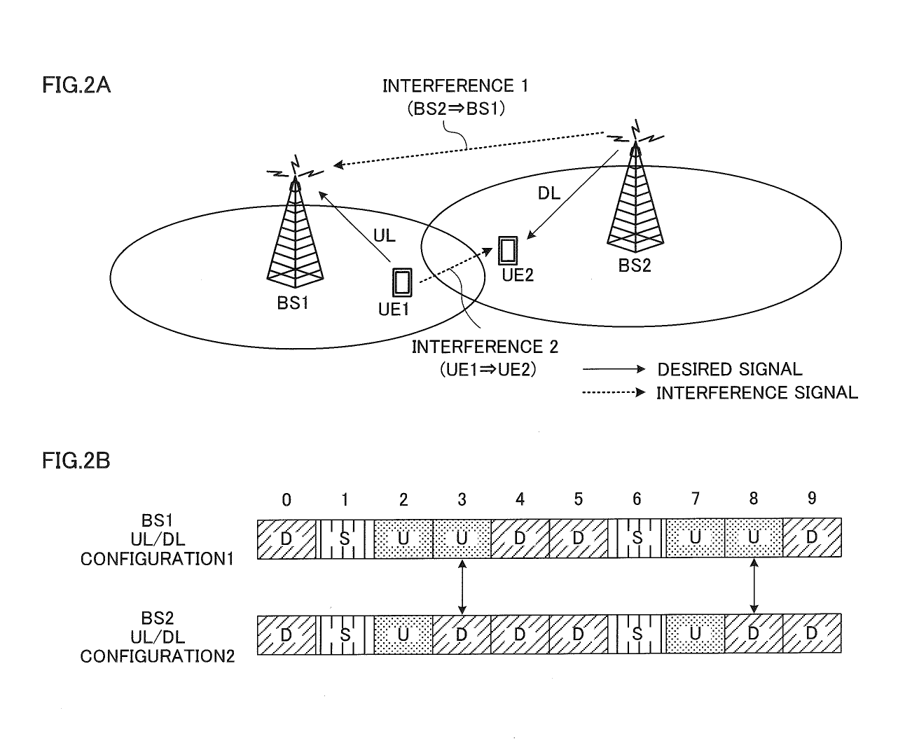

Inter-cell interference in dynamic TDD will be described below with reference to FIG. 2. Dynamic TDD refers to changing the configuration of uplink subframes and downlink subframes (DL/UL configuration) dynamically in a radio communication system where time division duplexing (TDD) is employed. As shown in FIG. 2A, a radio communication system where dynamic TDD is employed is formed by including a plurality of transmission/receiving points (here, radio base stations BS1 and BS2) and user terminals UE1 and UE2 that communicate with radio base stations BS1 and BS2.

In FIG. 2A, between radio base station BS1 and user terminal UE1 and between radio base station BS2 and user terminal UE2, radio communication is carried out by means of TDD. FIG. 2B shows a case, as an example, where radio base station BS1 adopts UL/DL configuration 1 and radio base station BS2 adopts UL/DL configuration 2.

In this case, in subframes 3 and 8, radio base station BS1 carries out UL transmission and radio base station BS2 carries out DL transmission. That is to say, in the same time region/the same frequency region, a downlink signal is transmitted from radio base station BS2 to user terminal UE2, and an uplink signal is transmitted from user terminal UE1 to radio base station BS1.

Consequently, the downlink signal that is transmitted from radio base station BS2 to user terminal UE2 may interfere with the uplink signal that is transmitted from user terminal UE1 to radio base station BS1 (interference 1 between radio base station BS1 and radio base station BS2). Also, the uplink signal that is transmitted from user terminal UE1 to radio base station BS1 may interfere with the downlink signal that is transmitted from radio base station BS2 to user terminal UE2 (interference 2 between user terminal UE1 and user terminal UE2) (see FIG. 2A).

As a result of this, there is a threat that the received quality of radio base station BS1 and the received quality of user terminal UE2 decrease in subframes 3 and 8. Also, generally speaking, the transmission power of downlink signals transmitted from a radio base station BS to a user terminal is greater than the transmission power of uplink signals transmitted from a user terminal UE to a radio base station BS. Consequently, the interference which downlink signals transmitted from a radio base station BS cause against uplink signals (for example, uplink control signals) transmitted from a user terminal has a particularly large impact (interference 1 in FIG. 2A).

In this way, in a radio communication system where dynamic TDD is employed, there is a threat that, when downlink subframes and uplink subframes overlap between neighboring cells, the quality of communication deteriorates due to inter-cell interference (in particular, the interference by downlink signals against an uplink control channel (PUCCH: Physical Uplink Control Channel) and so on (inter-BS interference)).

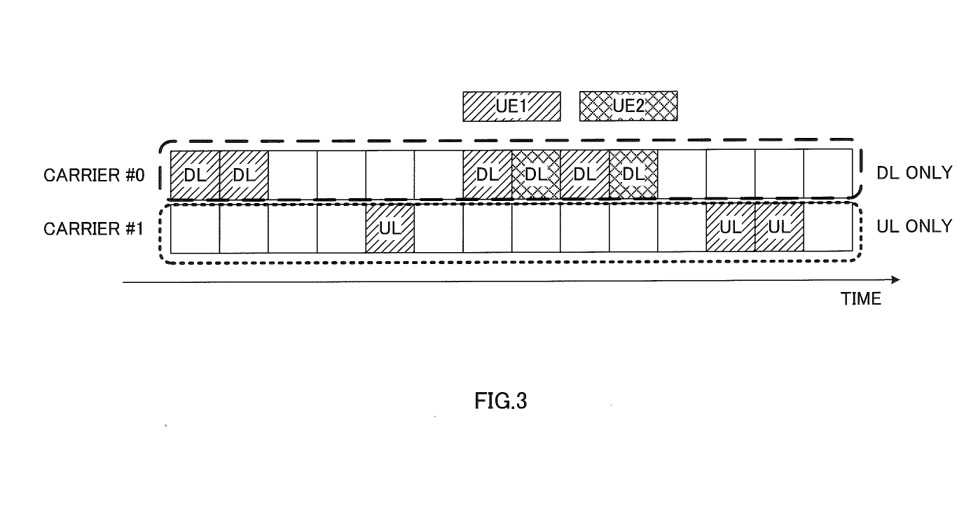

As a method of reducing such inter-cell interference, half-duplex FDD, which is shown in FIG. 3, is known. Although, in half-duplex FDD, different frequency resources (for example, component carriers (also simply referred to as “carriers”)) are assigned between the uplink and the downlink as in frequency division duplexing (FDD), subcarriers, resource blocks, etc.), an uplink signal and a downlink signal of a given user terminal UE are not transmitted and received at the same time. Half-duplex FDD is the same as TDD in that an uplink signal and a downlink signal of a given user terminal UE are transmitted and received at different times.

In half-duplex FDD that is shown in FIG. 3, a DL carrier (carrier #0 in FIG. 3) and a UL carrier (carrier #1 in FIG. 3) are assigned. Also, downlink signals and uplink signals for user terminal UE1 are transmitted and received in different subframes of different carriers. In half-duplex FDD, a carrier that is the same between neighboring cells (for example, carrier #0) assumes a single transmission direction (for example, DL alone in carrier #0). That is to say, a carrier that is the same between neighboring cells does not assume varying transmission directions. Consequently, it is possible to reduce the inter-cell interference. Meanwhile, half-duplex FDD requires a UL/DL paired carrier, and this makes the spectral efficiency poor.

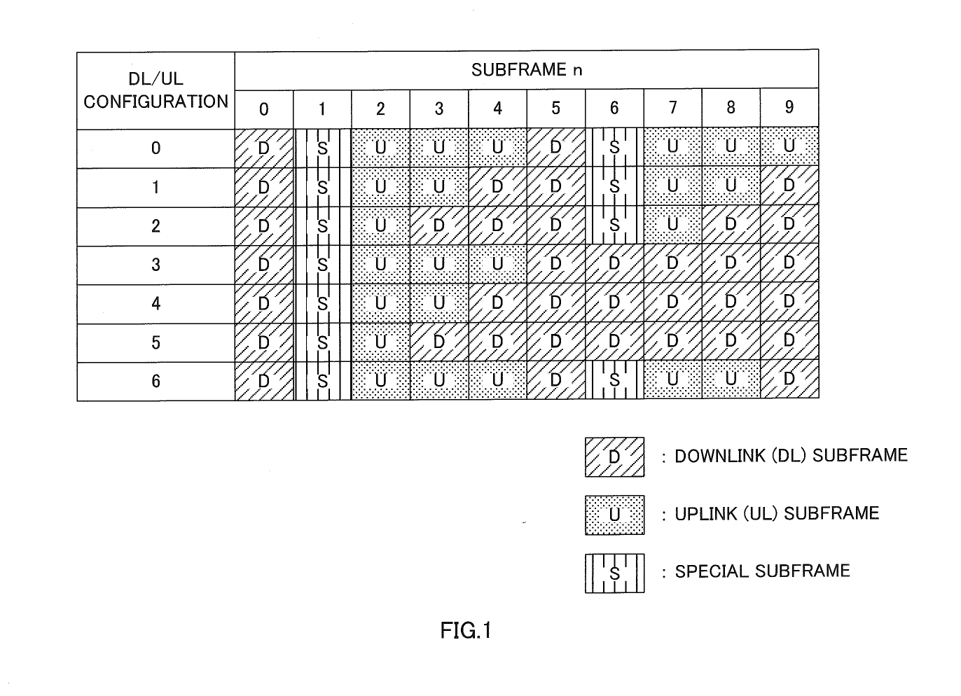

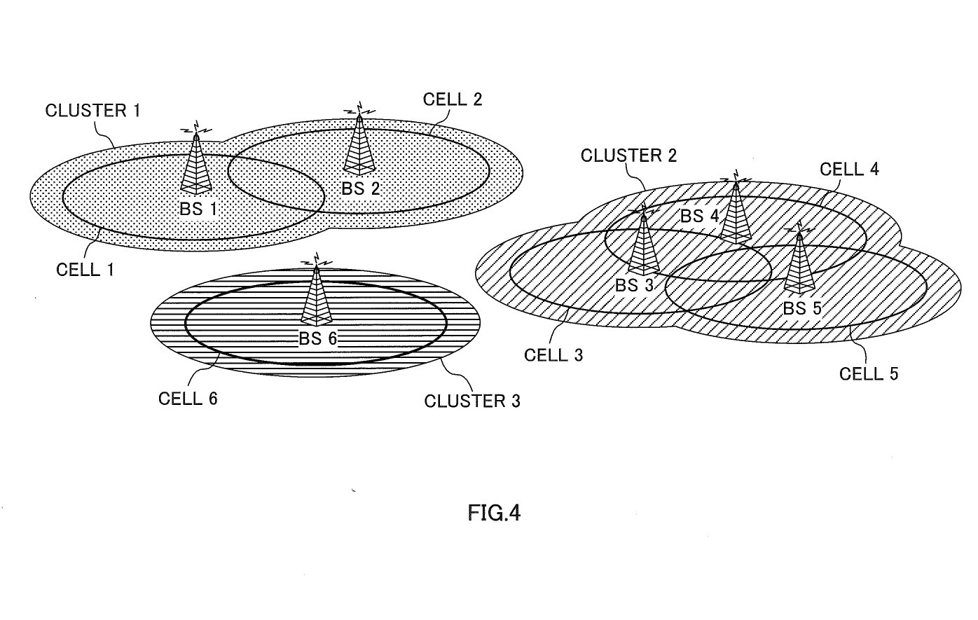

So, in a radio communication system in which dynamic TDD is employed, a study is in progress to execute cell clustering in order to reduce the inter-cell interference. As shown in FIG. 4, in cell clustering, a cluster is formed by grouping at least one neighboring cell. Also, the same UL/DL configuration is applied to all cells in the cluster (FIG. 1).

For example, in FIG. 4, cluster 1 is formed by grouping neighboring cells 1 and 2, cluster 2 is formed by grouping neighboring cells 3 to 5, and the cluster 3 is formed by grouping cell 6. In FIG. 4, the same UL/DL configuration is applied to the cells in the same cluster (for example, cells 1 and 2).

Since, in cell clustering, the same UL/DL configuration is applied between cells in a cluster, it does not occur that different transmission directions are assumed in the same subframe (UL in one and DL in the other). As a result of this, it is possible to prevent inter-cell interference in a cluster (which includes the inter-BS interference and the terminal interference in the cluster, and which is also referred to as “intra-cluster interference”). Note that there are sufficient distances between clusters, so that inter-cluster interference is negligible.

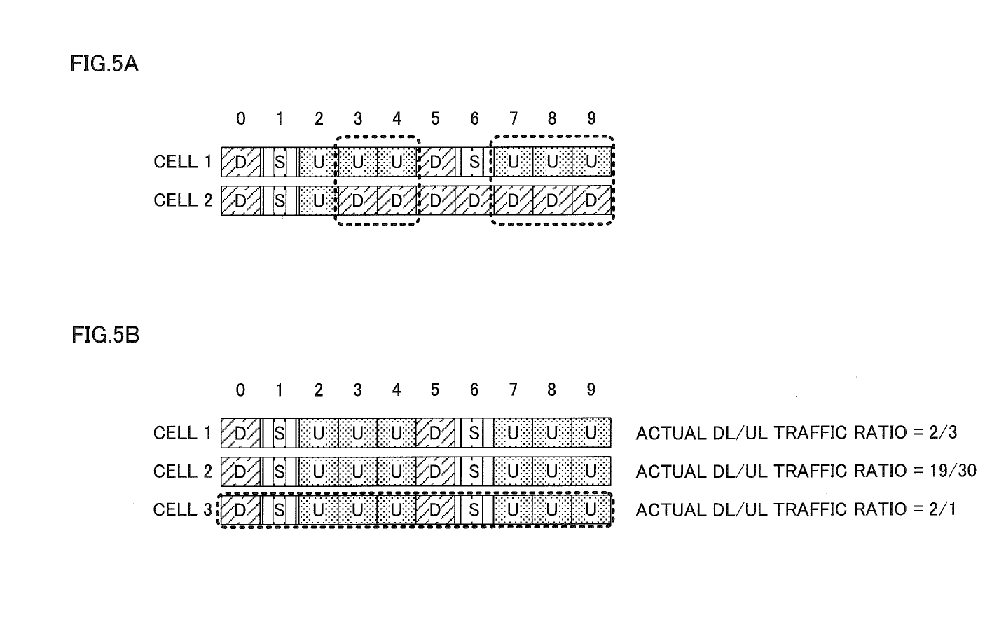

Now, examples of applying UL/DL configurations to cells in a cluster will be described in detail with reference to FIG. 5. In FIG. 5A, an example is shown where different UL/DL configurations are applied between cells in a cluster. To be more specific, in FIG. 5A, UL/DL configuration 0 is applied to cell 1, and UL/DL configuration 5 is applied to cell 2. In FIG. 5A, in five subframes (subframes 3, 4 and 7 to 9) in one radio frame, cells 1 and 2 assume different transmission directions. Consequently, the interference between cells 1 and 2 in the cluster increases.

In FIG. 5B, an example is shown where the same UL/DL configuration is applied among cells in a cluster. To be more specific, in FIG. 5B, UL/DL configuration 0 is applied to all of cells 1 to 3 in the cluster. In FIG. 5B, in all of the subframes in one radio frame, cells 1 to 3 assume the same transmission direction. Consequently, it is possible to reduce the interference among cells 1 to 3 in the cluster.

In UL/DL configuration 0 applied to cells 1 to 3, six subframes (subframes 2 to 4 and 7 to 9) in one radio frame are handled as uplink subframes and the other four subframes (subframes 0, 1, 5 and 6) are handled as downlink subframes. Note that subframes 1 and 6 are special subframes for switching between the downlink subframes and the uplink subframes. The special subframes are primarily used on the downlink, and therefore can be handled as downlink subframes.

Here, the ratios between downlink traffic and uplink traffic (hereinafter referred to as “DL/UL traffic ratios”) in cells 1, 2 and 3 are 2:3, 19:30 and 2:1, respectively. In cells 1 and 2 where uplink traffic is heavier than downlink traffic, traffic adaptation gain is achieved by applying UL/DL configuration 0, in which there are more uplink subframes than downlink subframes. On the other hand, in cell 3 where downlink traffic is heavier than uplink traffic, applying the same UL/DL configuration 0 as in cells 1 and 2 results in a loss of traffic adaptation gain.

As described above, when the same UL/DL configuration is applied to all cells in a cluster in order to reduce the inter-cell interference in the cluster, there is a threat that the traffic adaptation gain by virtue of dynamic TDD is lost. So, the present inventors have come up with the idea of preventing the loss of traffic adaptation gain by making it possible to apply UL/DL configurations to match the traffic in each cell in a cluster, while reducing the inter-cell interference in the cluster, by using at least one of fixed subframes in which the transmission direction is fixed in the cluster.

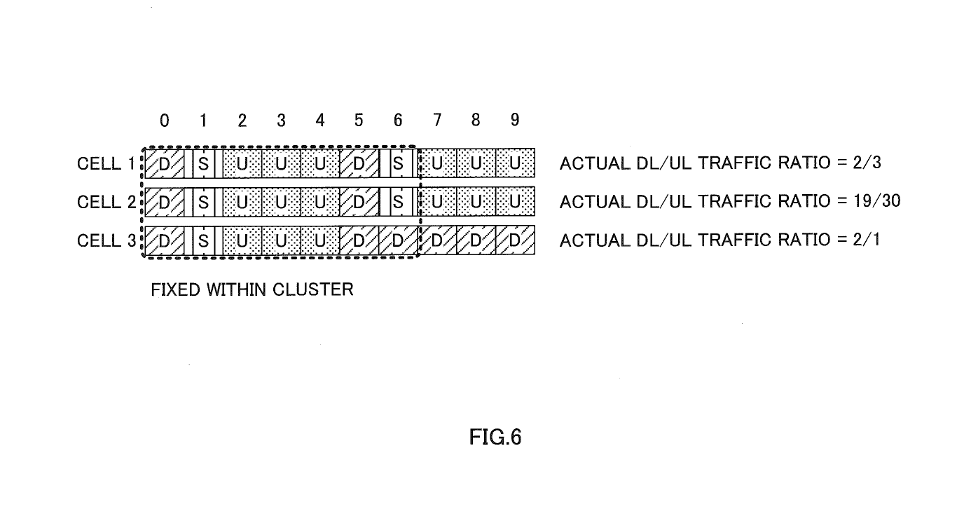

To be more specific, as shown in FIG. 6, among cells 1 to 3 in a cluster, the transmission direction in the cluster is DL in subframes 0, 1, 5 and 6 (where the special subframes (S) are handled as downlink subframes). Also, in subframes 2 to 4, the transmission direction in the cluster is UL. In this way, in each of subframes 0 to 6 in FIG. 6, the transmission direction in the cluster is fixed in one direction, so that it is possible to prevent the inter-cell interference in the cluster.

Meanwhile, in FIG. 6, UL/DL configuration 0 to provide more uplink subframes is applied to cells 1 and 2 where uplink traffic is heavy, and UL/DL configuration 3 to provide more downlink subframes is applied to cell 3 where downlink traffic is heavy, depending on the DL/UL traffic ratios. Consequently, compared to the case of applying the same UL/DL configuration among cells 1 to 3, it is possible to prevent the loss of traffic adaptation gain.

In this way, when fixed subframes in which the transmission direction is fixed in the cluster are provided, it is possible to reduce the inter-cell interference in the cluster, without applying the same UL/DL configuration between cells in the cluster. Also, as long as fixed subframes are provided, it is possible to apply different UL/DL configurations between cells, so that it is also possible to prevent the loss of traffic adaptation gain.

Now, the radio communication method according to the present invention will be described below in detail. The radio communication method according to the present invention is used in a radio communication system in which each radio base station BS in a cluster communicates with a user terminal UE by using a UL/DL configuration, which represents the configuration of at least one of uplink subframes and at least one of downlink subframes in a radio frame.

To be more specific, with the radio communication method according to the present invention, the subset to use in a cluster is selected from among a plurality of subsets, each of which includes a plurality of UL/DL configurations determined based on the number of fixed subframes in which the transmission direction is fixed in the cluster (cluster-level resource control). Also, from a plurality of UL/DL configurations included in the selected subset, the UL/DL configuration to use to communicate with a user terminal UE is selected (cell-level resource control).

In this way, with the radio communication method according to the present invention, resource control is executed on the cluster level between a plurality of radio base stations BS forming a cluster, and, furthermore, resource control on the cell level is executed in each radio base station BS in the cluster. By virtue of this resource control on multiple levels, it is possible to improve the traffic adaptation gain even more, while preventing inter-cell interference in the cluster.

Note that, although examples will be described below where a specific radio base station BS in a cluster serves as the cluster control station (cluster center) to execute cluster-level resource control, this is by no means limiting. The cluster control station is not limited to a radio base station BS in a cluster, and may be a control apparatus outside the cluster as well (which includes a radio base station, a core network apparatus, and so on). Also, each radio base station BS in a cluster may be a radio base station to form a small cell (small base station), or may be a radio base station to form a macro cell (macro base station).

Also, as for the UL/DL configuration to apply to each cell, although configurations that are defined in the LTE system (see FIG. 1) will be described below as examples, the applicable UL/DL configurations are by no means limited to these. Also, the cells may be radio base stations BS, transmission points and so on. Furthermore, the special subframes are used primarily in DL transmission and therefore may be handled as downlink subframes.

Also, in the radio communication method according to the present invention, a fixed subframe is a subframe in which the transmission direction is fixed to UL or to DL between cells in a cluster. On the other hand, a dynamic subframe is a subframe in which the transmission direction is not fixed between cells in a cluster. Note that the dynamic subframe may also be referred to as “flexible subframe,” “open subframe” and so on. Also, as will be described later, the dynamic subframe can be changed to a restricted subframe (including an empty subframe, which will be described later), in which uplink/downlink transmission or the uplink/downlink transmission power is controlled.

(Cluster-Level Resource Control)

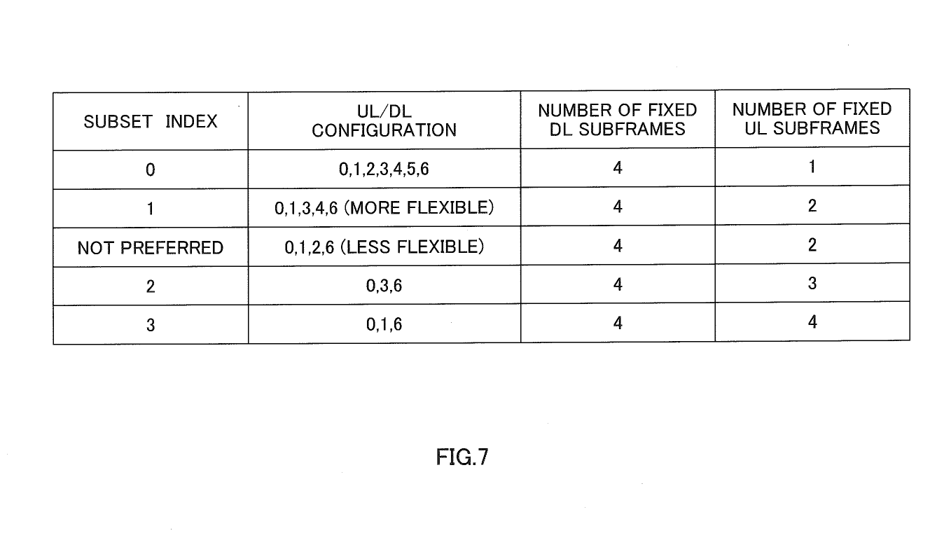

A plurality of subsets that are used in cluster-level resource control will be described with reference to FIGS. 7 to 11. A subset is a combination of UL/DL configurations that is determined based on the number of fixed subframes. Note that, in FIG. 7 to FIG. 11, the special subframes are handled as downlink subframes.

As shown in FIG. 7, each subset includes a plurality of UL/DL configurations that are determined based on the number of fixed subframes on the downlink (hereinafter referred to as “fixed downlink subframes”) and fixed subframes on the uplink (hereinafter referred to as “fixed uplink subframes”). Also, each subset is identified by subset information (for example, a subset index).

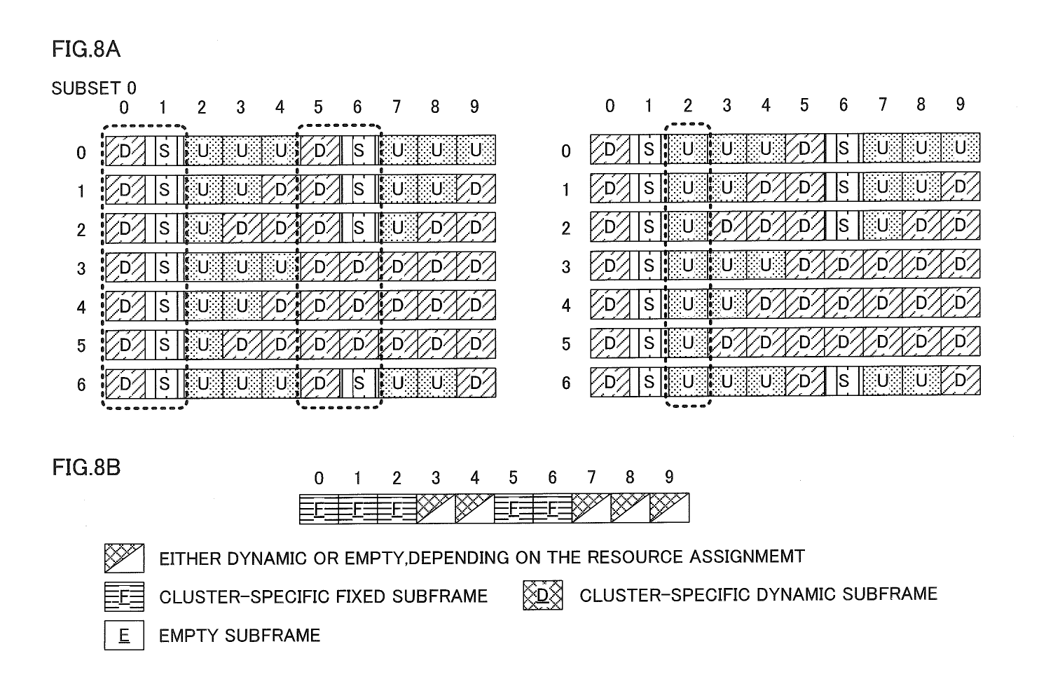

For example, subset 0 includes UL/DL configurations, in which the number of fixed downlink subframes is four and the number of fixed uplink subframes is one. When UL/DL configurations 0 to 6 shown in FIG. 1 are used, as shown in FIG. 8A, in all of UL/DL configurations 0 to 6, four subframes 0, 1, 5 and 6 serve as fixed downlink subframes, and one subframe 2 serves as a fixed uplink subframe. Consequently, subset 0 includes UL/DL configurations 0 to 6.

In subset 0, as shown in FIG. 8B, an equal number of dynamic subframes to fixed subframes (here, subframes 0, 1, 5 and 6, which are fixed downlink subframes, and subframe 2, which is a fixed uplink subframe) are provided. In this way, in subset 0, relatively a large number of dynamic subframes that can change the transmission direction among cells in a cluster are provided. Consequently, subset 0 is selected when the DL/UL traffic ratio varies significantly among the cells in the cluster (for example, when the DL/UL traffic ratios in cells 1, 2 and 3 are 1:1, 4:1 and 1:4, respectively).

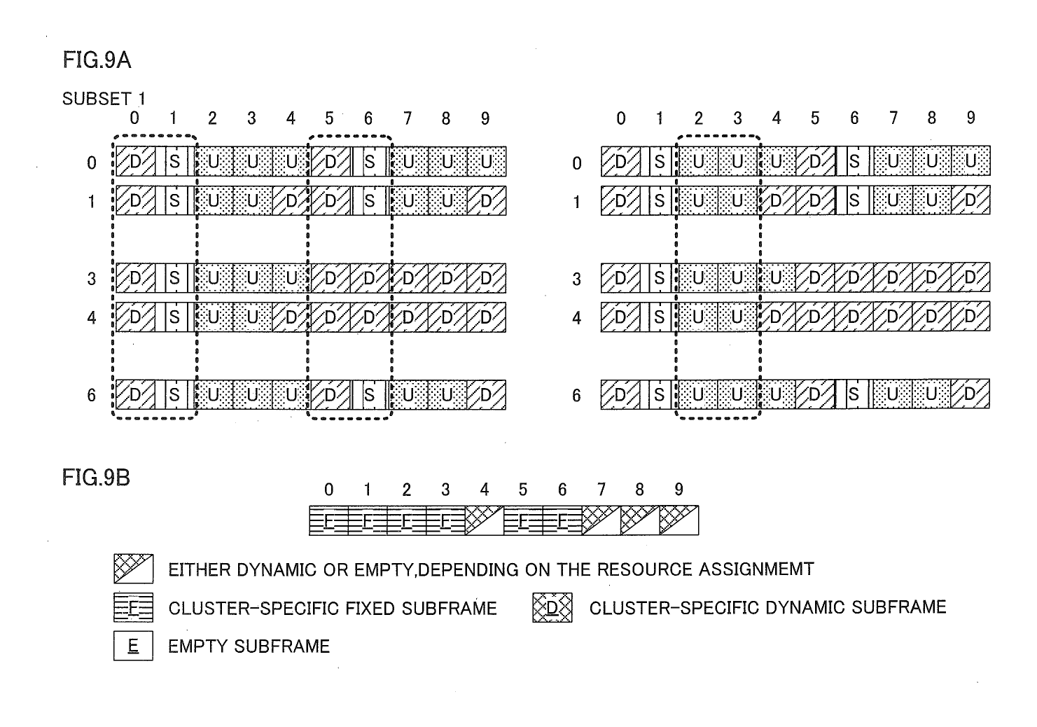

Also, subset 1 includes UL/DL configurations in which the number of fixed downlink subframes is four and the number of fixed uplink subframes is two. When UL/DL configurations 0 to 6 shown in FIG. 1 are used, as shown in FIG. 9A, in UL/DL configuration 0, 1, 3, 4 and 6, four subframes 0, 1, 5 and 6 serve as fixed downlink subframe, and two subframes 2 and 3 serve as fixed uplink subframes. Consequently, subset 1 includes UL/DL configurations 0, 1, 3, 4 and 6.

In subset 1, as shown in FIG. 9B, six fixed subframes, which are comprised of four fixed downlink subframes and two fixed uplink subframes, and four dynamic subframes are provided, so that it is possible to provide a relatively large number of downlink subframes. Consequently, subset 1 is selected when, although the DL/UL traffic ratio varies among the cells in the cluster, DL transmission is relatively heavy (for example, when the DL/UL traffic ratios in cells 1, 2 and 3 are 2:1, 4:3 and 3:4, respectively).

Note that, as for the combinations of UL/DL configurations in which the number of fixed downlink subframes is four and the number of fixed uplink subframes is two, as shown in FIG. 7, there are UL/DL configurations 0, 1, 2 and 6, apart from UL/DL configurations 0, 1, 3, 4 and 6. Here, it is preferable if there are a large number of types of UL/DL configurations that are applicable to the radio base stations BS in the cluster. Consequently, subset 1 includes UL/DL configurations 0, 1, 3, 4 and 6, which include a larger number of types than UL/DL configurations 0, 1, 2 and 6. In this way, when there are a plurality of combinations of UL/DL configurations in which the number of fixed downlink subframes and the number of fixed uplink subframes assume desirable values, the subset is a combination to provide a greater number of types of UL/DL configurations.

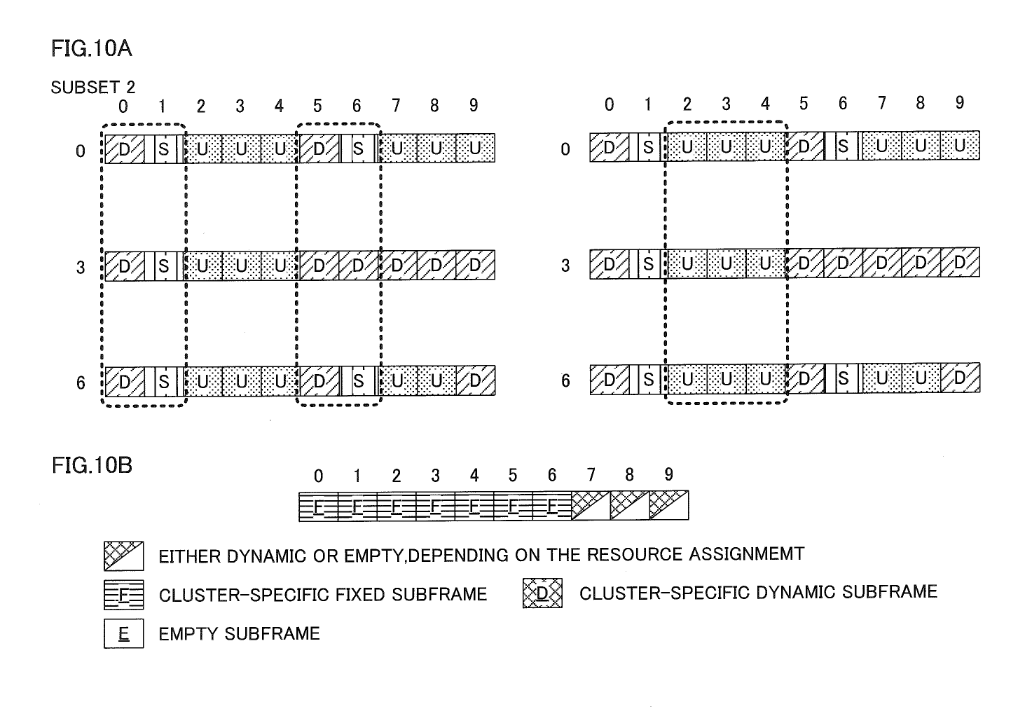

Also, subset 2 includes UL/DL configurations in which the number of fixed downlink subframes is four and the number of fixed uplink subframes is three. When UL/DL configurations 0 to 6 shown in FIG. 1 are used, as shown in FIG. 10A, in UL/DL configurations 0, 3 and 6, four subframes 0, 1, 5 and 6 serve as fixed downlink subframe and three subframes 2 to 4 serve as fixed uplink subframes. Consequently, subset 2 includes UL/DL configurations 0, 3 and 6.

In subset 2, as shown in FIG. 10B, seven fixed subframes, which are comprised of four fixed downlink subframes and three fixed uplink subframes, and three dynamic subframes are provided, so that it is possible to provide a relatively large number of uplink subframes. Consequently, subset 2 is selected when, although the DL/UL traffic ratio varies among the cells in the cluster, UL transmission is relatively heavy (for example, when the DL/UL traffic ratios in cells 1, 2 and 3 are 2:1, 5:6 and 3:4, respectively).

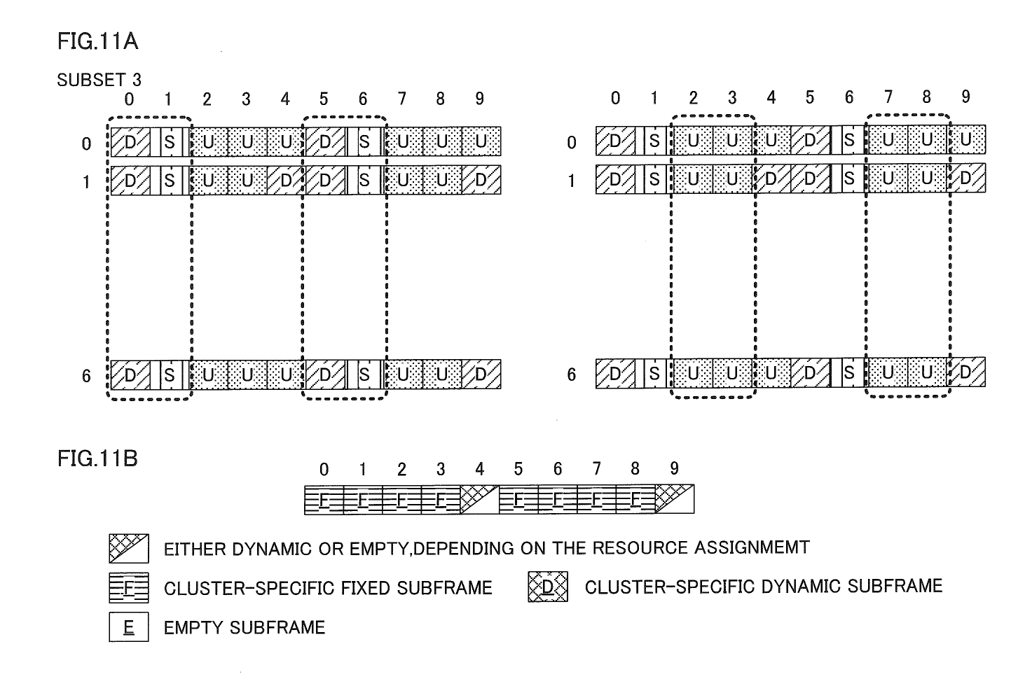

Also, subset 3 represents a combination of UL/DL configurations in which the number of fixed downlink subframes is four and the number of fixed uplink subframes is four. When UL/DL configurations 0 to 6 shown in FIG. 1 are used, as shown in FIG. 11A, in UL/DL configurations 0, 1 and 6, four subframes 0, 1, 5 and 6 serve as fixed downlink subframes and four subframes 2, 3, 7 and 8 serve as fixed uplink subframes. Consequently, subset 2 includes UL/DL configurations 0, 1 and 6.

In subset 3, as shown in FIG. 11B, eight fixed subframes, which are comprised of four fixed downlink subframes and four fixed uplink subframes, and two dynamic subframes are provided, so that the numbers of downlink subframes and uplink subframes do not differ significantly. Consequently, subset 3 is selected when the DL/UL traffic ratio is similarly low in each cell in the cluster (for example, when the DL/UL traffic ratios in cells 1, 2 and 3 are 1:1, 5:6 and 3:4, respectively).

In cluster-level resource control, the cluster control station selects the subset to use in the cluster (cluster-specific subset) from a plurality of subsets described above, based on interference information and/or traffic information in each radio base station BS (cell, transmission point, etc.) in the cluster.

Here, the interference information refers to information that represents the amount of interference in each radio base station BS (cell, transmission point, etc.), and includes, for example, the SINR (Signal to Interference plus Noise Ratio), the SNR (Signal to Noise ratio) and so on. Note that interference information may be referred to as “interference measurement results,” “interference level reports,” and so on.

Also, the traffic information refers to information that relates to UL and DL traffic in each radio base station BS (cell, transmission point, etc.). The traffic information may be information (UL/DL configuration number) that identifies the UL/DL configuration that is preferable to be employed in each radio base station BS, the DL/UL traffic ratio (which may be quantized), and the number of DL packets or the number of UL packets that are stored in the buffer of each radio base station BS in the cluster. Note that traffic information may be referred to as “traffic demand reports” and/or the like.

To be more specific, when interference information is relatively poor in each cell, the cluster control station may select a subset in which the number of fixed subframes is large (for example, subsets 2 and 3), in order to reduce the inter-cell interference. Alternatively, when interference information is relatively good in each cell, the cluster control station may select a subset in which the number of fixed subframes is small (the number of dynamic subframes is larger) (for example, subsets 0 and 1), in order to improve the traffic adaptation gain.

Also, the cluster control station may select a subset to include more UL/DL configurations that are desirable for application in each cell, based on traffic information. Also, when the UL/DL traffic ratio varies significantly in each cell, the cluster control station may select a subset with a large number of dynamic subframes (for example, subset 0). On the other hand, when the UL/DL traffic ratio is nearly equal in each cell, the cluster control station may select a subset with a large number fixed subframes (for example, subset 3).

Also, in cluster-level resource control, the cluster control station may re-select the subset to use in a cluster, semi-statically, based on a predetermined trigger. This re-selection may be conducted based on interference information and/or traffic information in each radio base station BS (cell, transmission point, etc.) in the cluster.

Subset information to represent the subset that is selected/re-selected (for example, a subset index) as described above may be reported to other radio base stations BS in the cluster, via, for example, an inter-BS interface such as the X2 interface.

Also, in cluster-level resource control, the cluster control station may assign fixed subframes and dynamic subframes in each radio base station BS in the cluster based on the selected subset, and report information about the assignment to the other radio base stations BS.

Note that the assignment information may be bitmap with an equal number of bits to the number of subframes constituting the radio frame. When bitmap is used, for example, the bits to correspond to the fixed subframes in FIG. 8B, FIG. 9B, FIG. 10B and FIG. 11B are set to “1,” and the bits to correspond to the dynamic subframes (or non-transmission subframes) may be set to “0.” Note that the setting of “1” or “0” is by no means limited to these.

Now, a case will be described below in detail in which a plurality of frequency/space resources are used in each radio base station BS (cell, transmission/receiving point, etc.) in a cluster. Note that the frequency/space resources refer to at least one of component carriers (also refereed to simply as “carriers”), predetermined frequency bands, subcarriers, resource blocks, beams and precoding matrices. Besides these, any resource apart from time resources may be used.

To be more specific, when a plurality of frequency/space resources are used in each radio base station BS in a cluster, the cluster control station assigns fixed subframes and dynamic subframes in each radio base station BS in the cluster based on a subset that is selected. Also, in part of the frequency/space resources that are used in each radio base station BS, the cluster control station assigns restricted subframes, instead of dynamic subframes, so as not to occur interference between the radio base station BS (cells, transmission points, etc.) in the cluster in dynamic subframes.

Note that the restricted subframes may be subframes in which neither uplink transmission nor downlink transmission is carried out (empty subframes), or may be subframes in which either uplink transmission or downlink transmission is carried out with restricted transmission power. Also, when restricted subframes are used instead of dynamic subframes, the above-described assignment information may contain information that identifies the dynamic subframes and the restricted subframes. Alternatively, the above-described assignment information may contain information that identifies the frequency/space resources where the dynamic subframes or the restricted subframes are assigned.

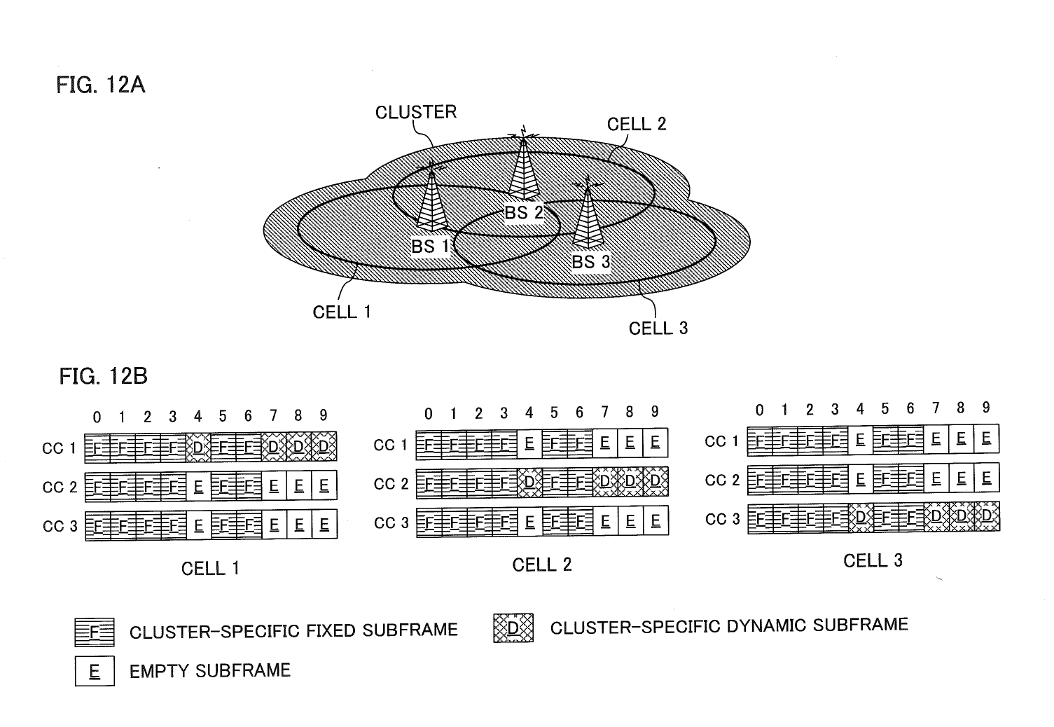

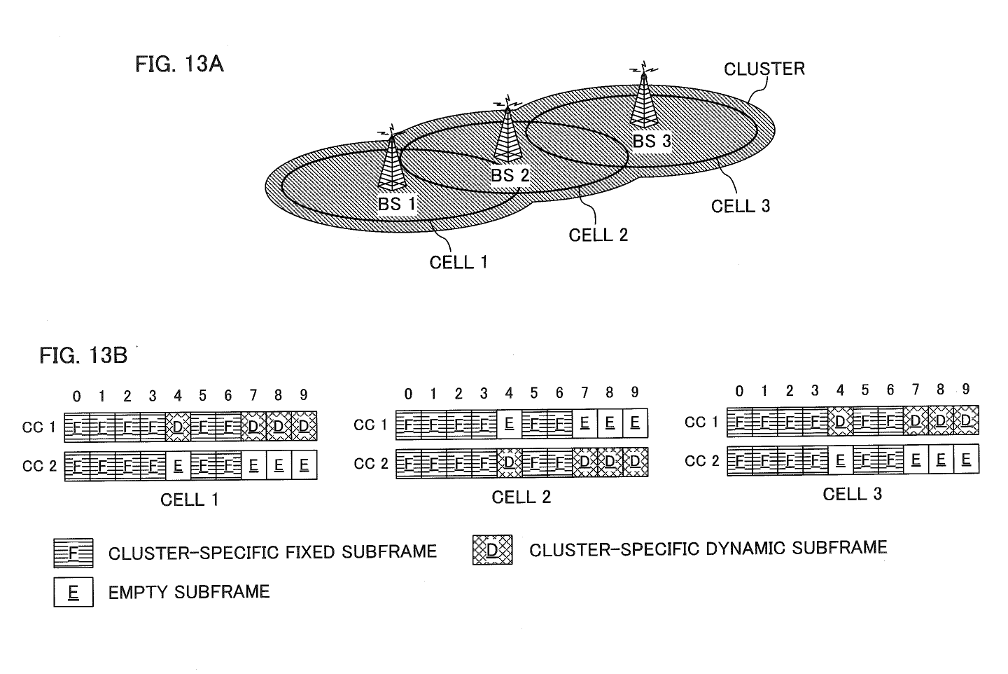

Now, with reference to FIG. 12 and FIG. 13, cases will be described below as examples where a plurality of component carriers (CCs) are used in each cell in a cluster as a plurality of frequency/space resources. With FIG. 12, an example will be described in which cells in a cluster are arranged to overlap each other geographically. Meanwhile, with FIG. 13, an example will be described in which part of the cells in a cluster are arranged not to overlap each other geographically.

A case will be assumed with FIG. 12A in which cells 1 to 3 in the cluster overlap each other geographically and in which cells 1 to 3 carry out carrier aggregation by using CC1 to CC3, respectively. In this case, the cluster control station (for example, radio base station BS2) assigns restricted subframes so that dynamic subframes are not assigned to the same CC among the cells.

For example, as shown in FIG. 12B, dynamic subframes are assigned to CC1 of cell 1, CC2 of cell 2 and CC3 of cell 3. Consequently, instead of dynamic subframes, restricted subframes (here, empty subframes in which neither uplink transmission nor downlink transmission is carried out) are assigned to CC2, and CC3 of cell 1, CC1 and CC3 of cell 2 and CC1 and CC2 of cell 3.

In this way, in FIG. 12B, the cluster control station assigns dynamic subframes for each cell in the cluster to mutually varying CCs. Also, the cluster control station assigns restricted subframes (here, empty subframes) to CCs other than the CCs where dynamic subframes are assigned in each cell. By this means, transmission is not carried out in different transmission directions in dynamic subframes of the same component carrier among the cells in the cluster, so that it is possible to reduce the to inter-cell interference in the dynamic subframes. Note that, in FIG. 12B, the above-described assignment information may contain information that identifies the CCs where the dynamic subframes (or restricted subframes) are assigned.

Meanwhile, a case will be assumed with FIG. 13A, in which cell 1 and cell 2 and cell 2 and cell 3 in the cluster overlap each other geographically, and in which, nevertheless, cell 1 and cell 3 do not overlap each other geographically, and cells 1 to 3 carry out carrier aggregation using CC1 and CC2. In this case, the cluster control station (for example, radio base station BS2) assigns restricted subframes, instead of dynamic subframes, to part of the CCs in CC1 and CC2, so as not to occur interference between cell 1 and cell 2 or cell 2 and cell 3 that overlap each other geographically.

For example, as shown in FIG. 13B, dynamic subframes are assigned to CC1 of cell 1, CC2 of cell 2 and CC1 of cell 3. Also, to CC2 of cell 1, CC1 of cell 2 and CC2 of cell 3, restricted subframes (here, empty subframes) are assigned, instead of dynamic subframes. Cells 1 and 3 do not overlap each other geographically, so that it is possible to assign dynamic subframes to the same CC1 in cells 1 and 3.

In this way, in FIG. 13B, the cluster control station assigns dynamic subframes for cells that overlap each other geographically in the cluster, to mutually different CCs. Also, the cluster control station assigns restricted subframes to CCs other than the CCs where dynamic subframes for cells that overlap each other geographically are assigned. By this means, transmission is not carried out in different transmission directions in dynamic subframes of the same component carrier among cells that overlap each other geographically in the cluster, so that it is possible to reduce the inter-cell interference in the dynamic subframes. Note that, in FIG. 13B, the above-described assignment information may contain information that identifies the CCs where the dynamic subframes (or restricted subframes) are assigned.

Also, in FIG. 13B, even within the cluster, dynamic subframes can be assigned to the same CC between cells that overlap each other geographically (in FIG. 13B, between cell 1 and 3), so that it is possible to improve the spectral efficiency.

In this way, when a plurality of frequency/space resources are used in each cell in a cluster, restricted subframes are used, instead of dynamic subframes, in part of the frequency/space resources, so that it is possible to prevent interference in subframes which assume different transmission directions between cells in the cluster, and reduce the inter-cell interference in the cluster.

(Cell-Level Resource Control)

In cell-level resource control, each radio base station BS in a cluster acquires subset information, which represents the subset that is selected by the cluster control station, and selects the UL/DL configuration to use to communicate with a user terminal UE from among a plurality of UL/DL configurations that are included in that subset.

For example, when subset 2 is selected out of subsets 0 to 3 in FIG. 7, each radio base station in the cluster selects a UL/DL configuration that matches the traffic, from UL/DL configurations 0, 3 and 6 that are shown in subset 2. To be more specific, each radio base station may select UL/DL configuration 3 when DL traffic is heavy, select UL/DL configuration 0 when UL traffic is heavy, and select UL/DL configuration 6 in other cases.

Also, in cell-level resource control, each radio base station BS in a cluster may change the UL/DL configuration dynamically, among a plurality of UL/DL configurations that are included in the subset, based on a predetermined trigger. Note that the UL/DL configuration is preferably changed in a shorter cycle than the reselection of the subset by the cluster control station.

(Detailed Operations)

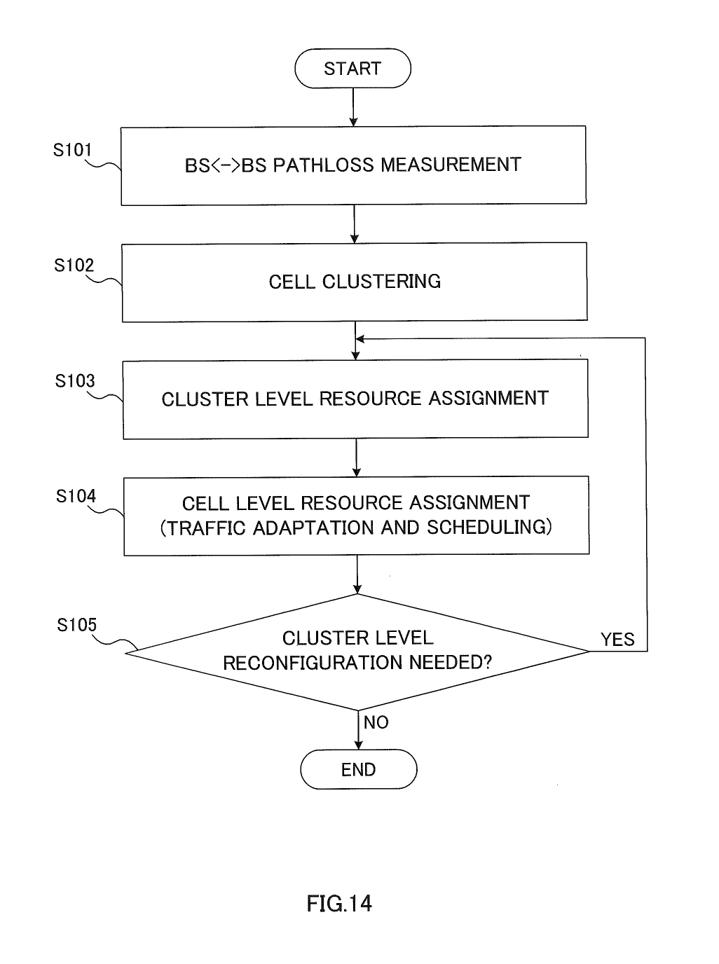

Now, with reference to FIG. 14 to FIG. 17, the operations of the radio communication method of the present invention will be described in detail.

Now, an overview of the operation of the radio communication method of the present invention will be described with reference to FIG. 14. With the radio communication method of the present invention, as shown in FIG. 14, the path loss between neighboring radio base stations BS (cells, transmission/receiving points, etc.) is measured (step S101). Based on the result of the path loss measurement between the radio base stations BS, a cluster is formed (step S102).

For example, a cluster may be formed by grouping at least one radio base station BS (cell) if the path loss between radio base stations BS is smaller than a predetermined threshold. Note that the radio base stations BS (cells) to form the cluster may be macro base stations (macro cells), may be small base stations (small cells), or may be both macro base stations and small base stations.

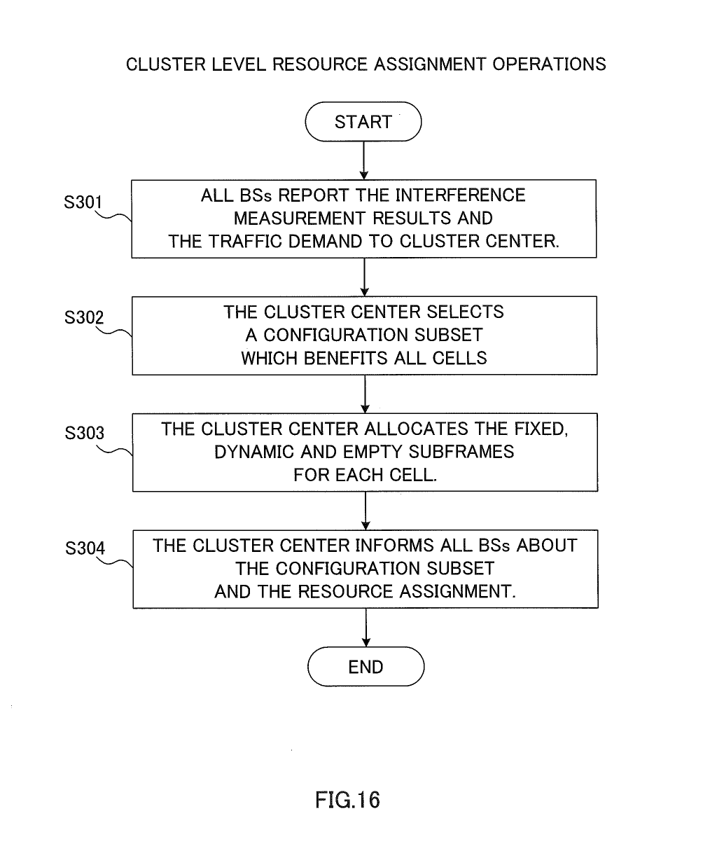

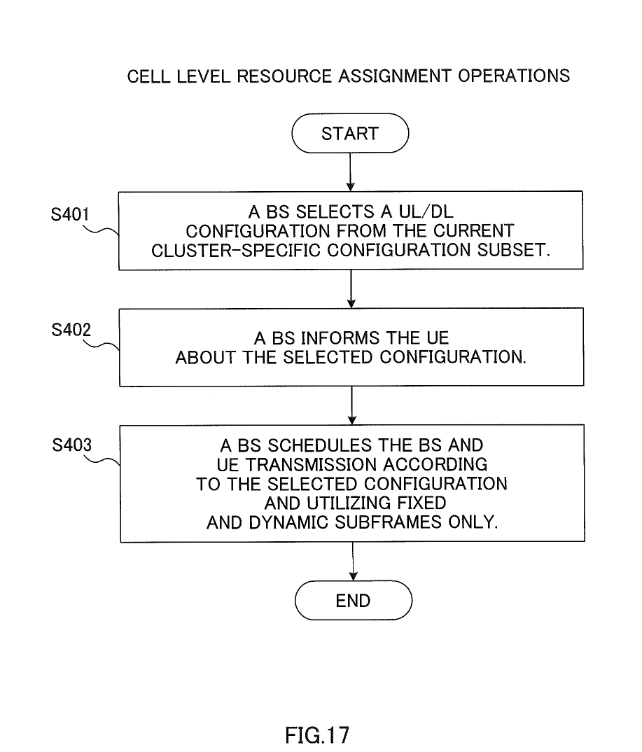

Next, the cluster control station (cluster center) carries out resource control on the cluster level (resource assignment) (see FIG. 16) (step S103). Note that the cluster control station may be a specific radio base station BS in the cluster, or may be a control apparatus outside the cluster. Also, each radio base station BS in the cluster carries out resource control on the cell level (resource assignment) (see FIG. 17) (step S104).

The cluster control station judges whether or not a cluster-level reconfiguration by means of a predetermined trigger is required, in a predetermined cycle (step S105). When a cluster-level reconfiguration is judged to be necessary, the operation returns to step S103.

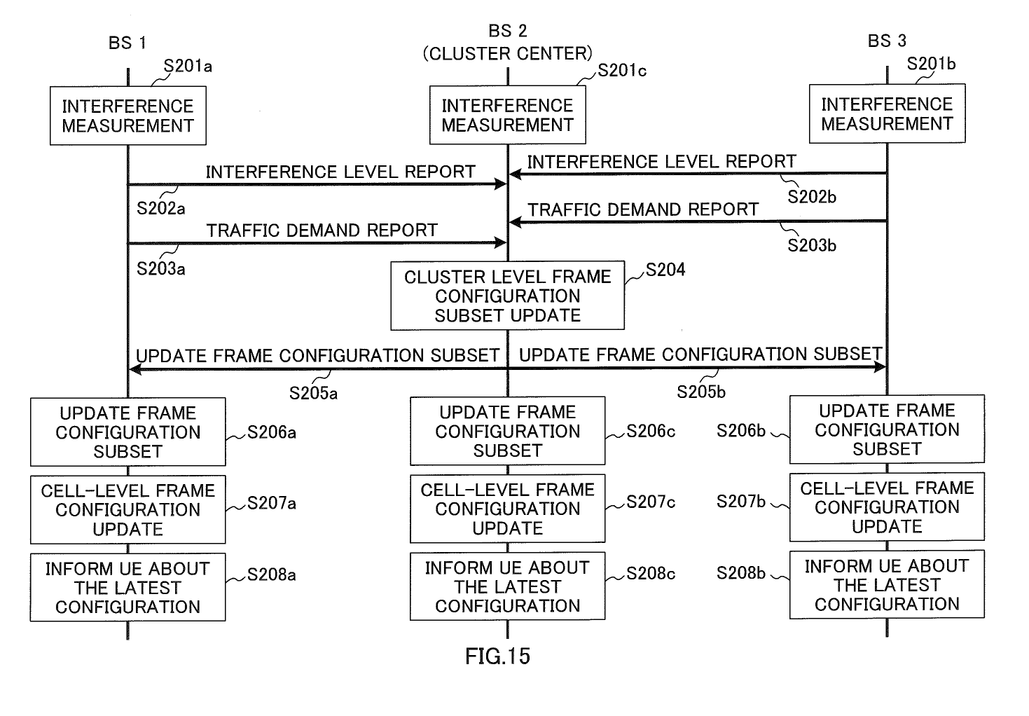

With reference to FIG. 15 to FIG. 17, the resource assignment operations on the cluster level and the cell level will be described. Assume, hereinafter, a cluster to include radio base stations BS1 to BS3 (cells 1 to 3) is formed. Also, although radio base station BS2 will be described to serve as the cluster control station, this is by no means limiting.

As shown in FIG. 15, radio base stations BS1 to BS3 in the cluster each measure interference (steps S201a to 201c). Also, radio base station BS1 and BS3 report interference information, which represents the measurement results, to the cluster control station (radio base station BS2) (steps S202a and 202b). Also, radio base stations BS1 and BS3 report traffic information to the cluster control station (steps S203a and 203b).

The cluster control station carries out cluster-level resource control based on the interference information and/or the traffic information in radio base stations BS1 to BS3 (step S204). Now, the cluster-level resource control operation in step S204 will be described in detail with reference to FIG. 16.

As shown in FIG. 16, the cluster control station (radio base station BS2) acquires interference information and/or traffic information in all of radio base stations BS1 to BS3 (cells 1 to 3) in the cluster (step S301). Note that, as mentioned earlier, the traffic information may contain information that identifies a desirable UL/DL configuration, the DL/UL traffic ratio, the number of uplink packets and downlink packets that are stored in the buffer, and so on.

The cluster control station selects the subset to use in the cluster from among a plurality of subsets (see FIG. 7) based on the interference information and/or the traffic information in radio base stations BS1 to BS3 in the cluster (step S302).

The cluster control station assigns fixed subframes and dynamic subframes or restricted subframes in radio base stations BS1 to BS3 in the cluster, based on the selected subset (step S303). To be more specific, the cluster control station assigns fixed subframes and dynamic subframes in accordance with the selected subset, as shown in FIG. 8B, FIG. 9B, FIG. 10B and FIG. 11B. Also, when a plurality of frequency/space resources are used in each of radio base stations BS1 to BS3 in the cluster, as shown in FIG. 12 and FIG. 13, the cluster control station may assign restricted subframes, instead of dynamic subframes, in part of the frequency/space resources in each radio base station BS.

The cluster control station reports subset information, which represents the selected subset in step S303, and the assignment information in step S304, to the other radio base stations BS in the cluster (step S304). Note that, as mentioned earlier, the assignment information may be bitmap with an equal number of bits to the number of subframes constituting the radio frame. Also, the assignment information may contain information that identifies the dynamic subframes and the restricted subframes. For example, in the cases illustrated in FIG. 12 and FIG. 13, the assignment information may contain information as to in which CCs dynamic subframes (or restricted subframes) are used.

As described above, cluster-level resource control is executed by the cluster control station. Steps S205a and S205b of FIG. 15 involve the same operation as in step S304 of FIG. 16, and therefore will not be described again.

Next, as shown in FIG. 15, radio base stations 1 to 3 in the cluster each perform resource control on the cell level (steps S206a to S206c). The cell-level resource control operations in steps S206a to S206c will be described in detail with reference to FIG. 17.

As shown in FIG. 17, each radio base station BS in the cluster acquires subset information (for example, a subset index and/or the like), which represents a subset that is selected from a plurality of subsets, and selects the UL/DL configuration to use to communicate with a user terminal UE from a plurality of UL/DL configurations that are included in this subset (step S401). For example, when subset information to represent subset 0 is acquired, each radio base station BS selects a UL/DL configuration to match the traffic from subsets 0 to 6 shown in FIG. 6.

Each radio base station BS reports UL/DL configuration information (for example, a UL/DL configuration number and/or the like), which represents the selected UL/DL configuration, to the user terminal UE (step S402). Each radio base station BS carries out scheduling (radio resource assignment) to communicate with the user terminal UE, in accordance with the UL/DL configuration information and the assignment information of fixed subframes and dynamic subframes or restricted subframes (step S403).

As described above, cell-level resource control is executed by each radio control station BS in the cluster. Next, as shown in FIG. 15, each radio base station BS updates the UL/DL configuration based upon a predetermined trigger (steps S207a to 207c). To be more specific, each radio base station BS updates to a UL/DL configuration that matches the traffic, from a plurality of UL/DL configurations that are included in the subset. The UL/DL configuration may be updated in this way in a shorter cycle than the cycle of updating the subset.

Each radio base station BS in the cluster reports UL/DL configuration information, which represents the updated UL/DL configuration, to the user terminal UE, and communicates with the user terminal UE (steps S208a to 208c).

As described above, with the radio communication method according to the present invention, the subset to use in a cluster is selected from a plurality of subsets that are determined based on the number of fixed subframes, and, UL/DL configurations to match each cell's traffic are selected from a plurality of UL/DL configurations that are shown in this subset. By this means, it is possible to prevent the loss of traffic adaptation gain, while reducing the inter-cell interference in the cluster.

(Structure of Radio Communication System)

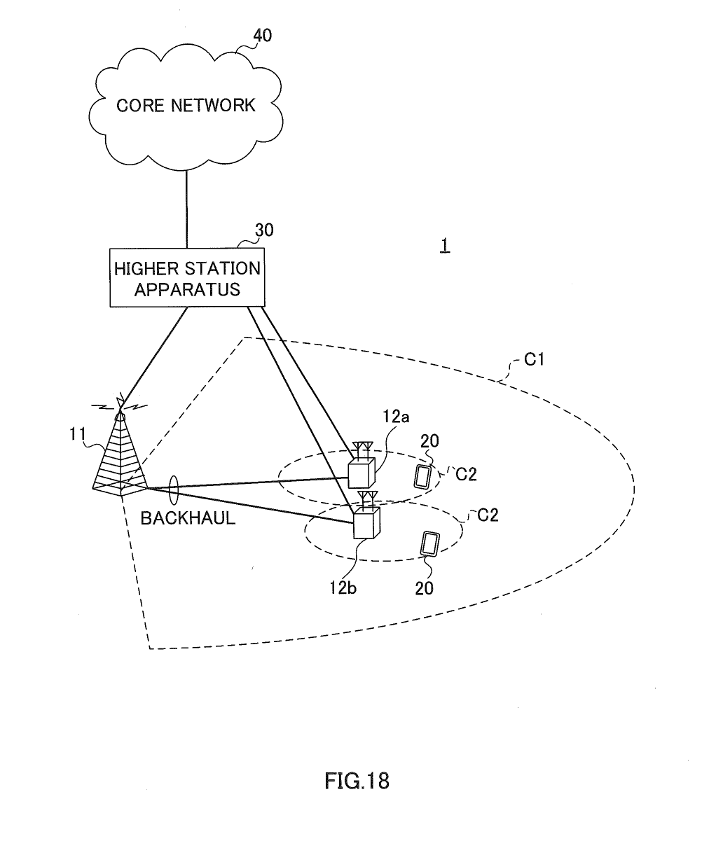

Now, the structure of the radio communication system according to the present embodiment will be described. In this radio communication system, the above-described radio communication method is employed. A schematic structure of the radio communication system according to the present embodiment will be described with reference to FIG. 18 to FIG. 22.

FIG. 18 is a diagram to show a schematic configuration of the radio communication system according to the present embodiment. As shown in FIG. 18, a radio communication system 1 includes a macro base station 11, which forms a macro cell C1, and small base stations 12a and 12b, which are placed in the macro cell C1 and which form small cells C2 that are narrower than the macro cell C1. The user terminals 20 are structured to be capable of carrying out radio communication with at least one of the macro base station 11 and the small base stations 12a and 12b (hereinafter collectively referred to as “small base stations 12”). Note that the numbers of the macro base station 11 and the small base stations 12 are not limited to those illustrated in FIG. 18.

In the macro cell C1 and the small cells C2, the same frequency band may be used, or different frequency bands may be used. Also, the macro base station 11 and each small base station 12 may be connected by wire connection (for example, via optical fiber and/or non-optical fiber), or may be connected by wireless connection. The macro base station 11 and the small base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these.

Note that the macro base station 11 is a radio base station having a relatively wide coverage, and may be referred to as an “eNodeB (eNB),” a “radio base station,” a “transmission point” and so on. The small base stations 12 are radio base stations that have local coverages, and may be referred to as “RRHs (Remote Radio Heads),” “pico base stations,” “femto base stations,” “Home eNodeBs,” “transmission points,” “eNodeBs (eNBs)” and so on. The user terminals 20 are terminals to support various communication schemes such as LTE and LTE-A, and may not only be mobile communication terminals, but may also be fixed communication terminals as well.

In the radio communication system 1, a cluster (see FIG. 4) may be formed by a plurality of macro base stations 11, or may be formed by a plurality of small base stations 12. Also, a cluster may be formed by including macro base stations 11 and small base stations 12.

Also, in the radio communication system 1, the cluster control station may be the macro base station 11 in the cluster, may be a small base station 12 in the cluster, or may be a control apparatus outside the cluster (for example, a macro base station if the cluster is formed by small base stations).

Also, in the radio communication system 1, as radio access schemes, OFDMA (Orthogonal Frequency Division Multiple Access) is applied to the downlink, and SC-FDMA (Single-Carrier Frequency Division Multiple Access) is applied to the uplink.

Also, in the radio communication system 1, a downlink shared channel (PDSCH: Physical Downlink Shared Channel), which is used by each user terminal 20 on a shared basis, downlink control channels (a PDCCH (Physical Downlink Control Channel), an EPDCCH (Enhanced Physical Downlink Control Channel), a PCFICH, a PHICH, a broadcast channel (PBCH) and so on), and so on are used as downlink communication channels. User data and higher control information are transmitted by the PDSCH. Downlink control information (DCI) is transmitted by the PDCCH and the EPDCCH.

Also, in the radio communication system 1, an uplink shared channel (PUSCH: Physical Uplink Shared Channel), which is used by each user terminal 20 on a shared basis, an uplink control channel (PUCCH: Physical Uplink Control Channel) and so on are used as uplink communication channels. User data and higher control information are transmitted by the PUSCH. Also, by the PUCCH, downlink radio quality information (CQI: Channel Quality Indicator), delivery acknowledgement information (ACKs/NACKs) and so on are transmitted.

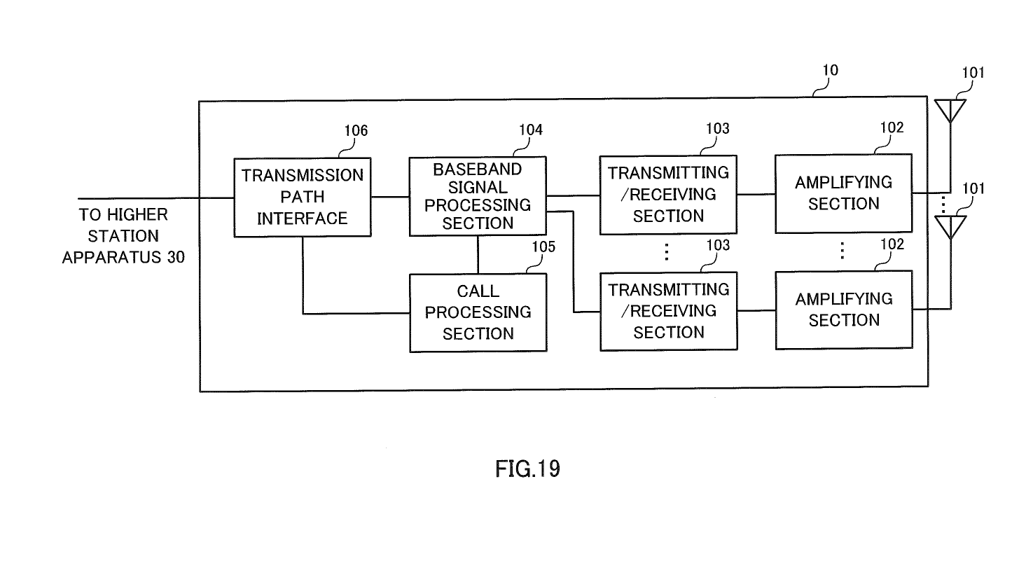

Hereinafter, the macro base station 11 and the small base stations 12 will be collectively referred to as “radio base station 10,” unless distinction needs to be drawn otherwise. FIG. 19 is a diagram to show an overall structure of a radio base station 10 according to the present embodiment. The radio base station 10 has a plurality of transmitting/receiving antennas 101 for MIMO transmission, amplifying sections 102, transmitting/receiving sections 103, a baseband signal processing section 104, a call processing section 105 and a transmission path interface 106.

User data to be transmitted from the radio base station 10 to a user terminal 20 on the downlink is input from the higher station apparatus 30, into the baseband signal processing section 104, via the transmission path interface 106.

In the baseband signal processing section 104, a PDCP layer process, division and coupling of the user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is transferred to each transmitting/receiving section 103. Furthermore, downlink control signals are also subjected to transmission processes such as channel coding and an inverse fast Fourier transform, and transferred to each transmitting/receiving section 103.

Each transmitting/receiving section 103 converts the downlink signals, which are pre-coded and output from the baseband signal processing section 104 on a per antenna basis, into a radio frequency band. The amplifying sections 102 amplify the radio frequency signals having been subjected to frequency conversion, and transmit the results through the transmitting/receiving antennas 101.

On the other hand, as for uplink signals, radio frequency signals that are received in the transmitting/receiving antennas 101 are each amplified in the amplifying sections 102, converted into baseband signals through frequency conversion in each transmitting/receiving section 103, and input in the baseband signal processing section 104.

In the baseband signal processing section 104, the user data that is included in the input uplink signals is subjected to an FFT process, an IDFT process, error correction decoding, a MAC retransmission control receiving process, and RLC layer and PDCP layer receiving processes, and transferred to the higher station apparatus 30 via the transmission path interface 106. The call processing section 105 performs call processing such as setting up and releasing communication channels, manages the state of the radio base station 10 and manages the radio resources.

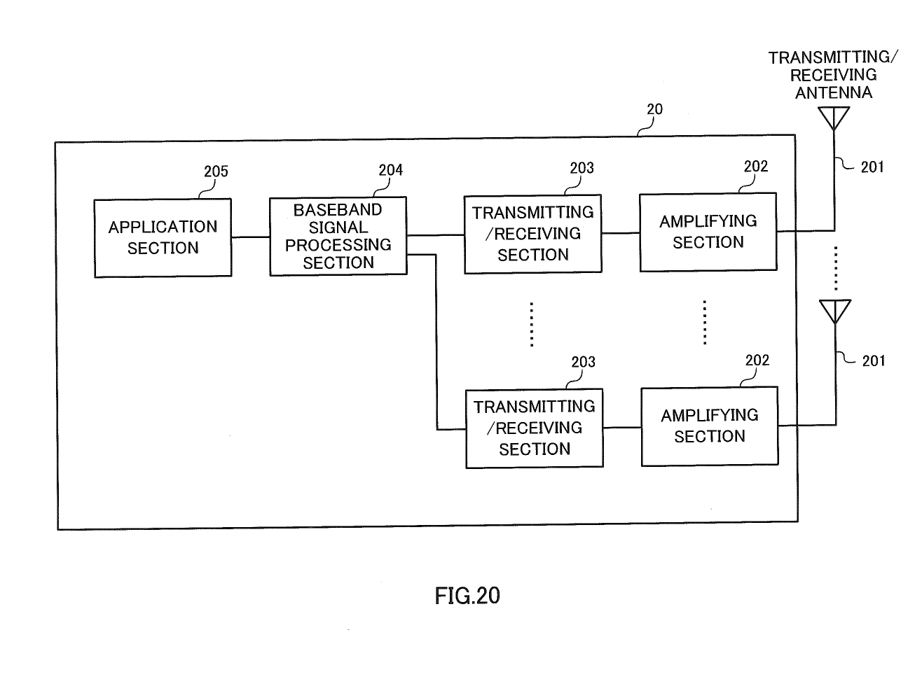

FIG. 20 is a diagram to show an overall structure of a user terminal 20 according to the present embodiment. The user terminal 20 has a plurality of transmitting/receiving antennas 201 for MIMO transmission, amplifying sections 202, transmitting/receiving sections 203, a baseband signal processing section 204 and an application section 205.

As for downlink signals, radio frequency signals that are received in a plurality of transmitting/receiving antennas 201 are each amplified in the amplifying sections 202, subjected to frequency conversion in the transmitting/receiving sections 203, and input in the baseband signal processing section 204. In the baseband signal processing section 204, an FFT process, error correction decoding, a retransmission control receiving process and so on are performed. The user data that in included in the downlink signals is transferred to the application section 205. The application section 205 performs processes related to higher layers above the physical layer and the MAC layer. The broadcast information in the downlink data is also transferred to the application section 205.

Meanwhile, uplink user data is input from the application section 205 to the baseband signal processing section 204. In the baseband signal processing section 204, a retransmission control (H-ARQ (Hybrid ARQ)) transmission process, channel coding, precoding, a DFT process, an IFFT process and so on are performed, and the result is transferred to each transmitting/receiving section 203. Baseband signals that are output from the baseband signal processing section 204 are converted into a radio frequency band in the transmitting/receiving sections 203. After that, the amplifying sections 202 amplify the radio frequency signals having been subjected to frequency conversion, and transmit the results from the transmitting/receiving antennas 201.

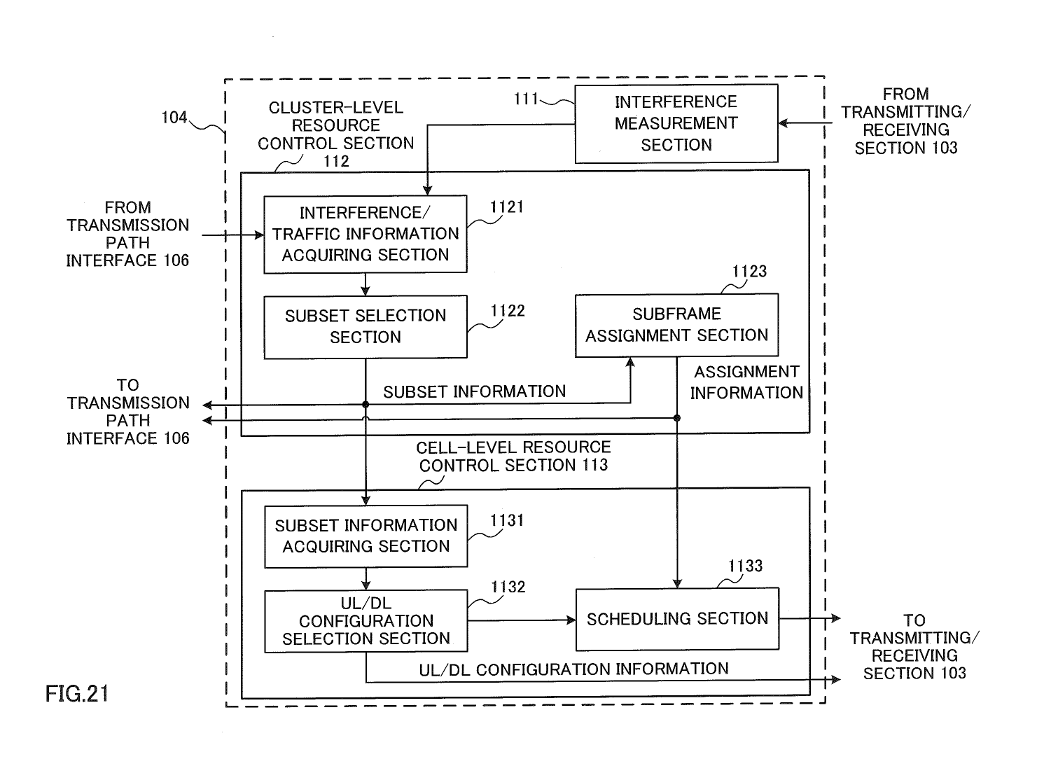

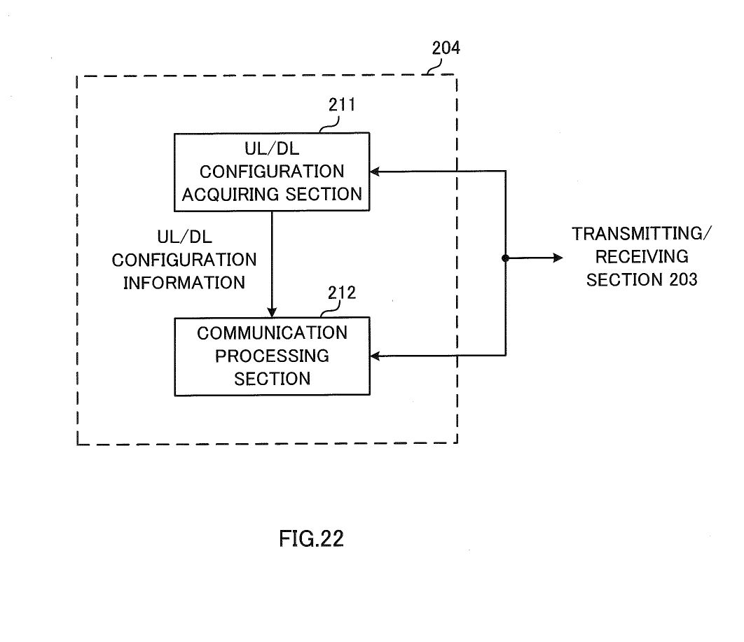

Next, the functional structures of the radio base station 10 and the user terminal 20 will be described in detail with reference to FIG. 21 and FIG. 22.

FIG. 21 is a functional structure diagram of the radio base station 10 according to the present embodiment. Note that the following functional structure is formed with the baseband signal processing section 104 and so on provided in the radio base station 10. Also, hereinafter, the functional structure of the radio base station 10, which operates as the cluster control station, will be primarily described.

As shown in FIG. 21, the radio base station 10 has an interference measurement section 111, a cluster-level resource control section 112, and a cell-level resource control section 113. Note that, when the radio base station 10 operates as a radio base station 10 other than the cluster control station in the cluster, the cluster-level resource control section 112 may be omitted.

The interference measurement section 111 measures the level of interference in the radio base station 10. The level of interference may be, for example, the level of interference of any of the reference signals (the CRS, the CSI-RS, etc.), the data signal and the control channel signal.

The cluster-level resource control section 112 has an interference/traffic information acquiring section 1121, a subset selection section 1122 and a subframe assignment section 1123.

The interference/traffic information acquiring section 1121 acquires interference information in each radio base station 10. To be more specific, the interference/traffic information acquiring section 1121 acquires the interference information in the subject radio base station, from the interference measurement section 111. Also, the interference/traffic information acquiring section 1121 acquires the interference information in the other radio base stations 10, from the other radio base stations 10, via the transmission path interface 106. Note that the method of acquiring interference information is by no means limited to this.

Also, the interference/traffic information acquiring section 1121 acquires the traffic information in each radio base station 10. To be more specific, the interference/traffic information acquiring section 1121 determines the traffic information in the subject radio base station (a desirable UL/DL configuration, the DL/UL traffic ratio, the number of uplink/downlink packets that are stored in the buffer, etc.) based on the scheduling result in the scheduling section 1133, the selection result in the UL/DL configuration selection section 1132, and so on. Also, the interference/traffic information acquiring section 1121 acquires the traffic information in the other radio base stations 10 in the cluster, from the other radio base stations 10, via the transmission path interface 106. Note that the method of acquiring traffic information is not limited to this.

The subset selection section 1122 selects the subset to use in the cluster, from a plurality of subsets (for example, FIG. 7) each of which includes a plurality of UL/DL configurations determined based on the number of fixed subframes. To be more specific, the subset selection section 1122 selects the subset based on the interference information and/or the traffic information in each radio base station 10.

Also, the subset selection section 1122 reports subset information, which represents the selected subset (for example, the subset index in FIG. 7), to the other radio base stations 10 in the cluster via the transmission path interface 106. Also, the subset selection section 1122 outputs the subset information to the UL/DL configuration selection section 1132 and the subframe assignment section 1123. The subset selection section 1122 constitutes the subset selection section and the subset information reporting section of the present invention.

The subframe assignment section 1123 assigns fixed subframes and dynamic subframes in each radio base station 10 in the cluster, based on the subset that is selected in the subset selection section 1122 (FIGS. 8B, 9B, 10B and 11B). Also, when a plurality of frequency/space resources (described above) are used in each radio base station in the cluster, the subframe assignment section 1123 assigns restricted subframes, in which uplink/downlink transmission or the uplink/downlink transmission power is controlled, instead of dynamic subframes, to part of the frequency/space resources that are used in each radio base station 10, so as not to occur interference between the radio base stations 10 in dynamic subframes.

Also, the subframe assignment section 1123 reports assignment information, which represents the assignment of fixed subframes and dynamic subframe or restricted subframes, to the other radio base stations 10 in the cluster via the transmission path interface 106. Also, the subframe assignment section 1123 outputs the assignment information to the scheduling section 1133. The subframe assignment section 1123 constitutes the assignment section and the assignment information reporting section of the present invention.

The cell-level resource control section 113 has a subset information acquiring section 1131, a UL/DL configuration selection section 1132, and a scheduling section 1133.

The subset information acquiring section 1131 acquires subset information, which represents the subset that is selected in the subset selection section 1122. Note that, when the radio base station 10 operates as a radio base station 10 other than the cluster control station in the cluster, although not illustrated, the subset information acquiring section 1131 may acquire the subset information from the cluster control station via the transmission path interface 106.

The UL/DL configuration selection section 1132 selects the UL/DL configuration to use to communicate with the user terminal 20 from a plurality of UL/DL configurations that are shown in the subset information.

Also, the UL/DL configuration selection section 1132 reports UL/DL configuration information, which represents the UL/DL configuration that is selected (for example, the UL/DL configuration number, the UL/DL configuration index, etc.), to the user terminal 20. For example, the UL/DL configuration information may be reported to the user terminal UE as higher layer control information to be sent through RRC signaling and MAC signaling, may be transmitted by the PDCCH or the EPDCCH as downlink control information (DCI), or may be broadcast by the PBCH as broadcast information.

The scheduling section 1133 carries out scheduling (assigns the PUSCH and the PDSCH) based on the UL/DL configuration selected in the UL/DL configuration selection section 1132. Also, the scheduling section 1133 may carry out scheduling in accordance with information about the assignment of fixed subframes and dynamic subframes or restricted subframes by the subframe assignment section 1123. Scheduling information (UL grants, DL grants, etc.) to represent the scheduling result may be transmitted by the PDCCH as DCI.

FIG. 22 is a functional structure diagram of a user terminal 20 according to the present embodiment. Note that the following functional structure is formed with the baseband signal processing section 204 provided in the user terminal 20 and so on.

As shown in FIG. 22, the user terminal 20 has a UL/DL configuration acquiring section 211 and a communication processing section 212.

The UL/DL configuration acquiring section 211 acquires UL/DL configuration information that is reported from the radio base station 10. As noted earlier, the UL/DL configuration information may be reported to the user terminal UE as higher layer control information to be sent through RRC signaling and MAC signaling, may be transmitted by the PDCCH or the EPDCCH as downlink control information (DCI), or may be broadcast by the PBCH as broadcast information.

The communication processing section 212 carries out processes for communicating with the radio base station 10 (for example, modulation, coding, demodulation, decoding, etc.) based on the UL/DL configuration information that is acquired in the UL/DL configuration acquiring section 211. Also, the communication processing section 212 may carry out processes for communicating with the radio base station 10 based on scheduling information that is included in the DCI from the radio base station 10.

Note that, according to the present invention, a radio base station 10 in a cluster other than the cluster control station is a radio base station 10 in the cluster that communicates with a user terminal 20 by using a UL/DL configuration, which represents the configuration of uplink subframes and downlink subframes in a radio frame, has a subset information acquiring section 1131 that acquires subset information, which represents the subset to use in the cluster, selected from a plurality of subsets each of which includes a plurality of UL/DL configurations, and a UL/DL configuration selection section 1132 that selects the UL/DL configuration to use to communicate with the user terminal, from a plurality of UL/DL configurations that are included in the selected subset, and the plurality of subsets are determined based on the number of fixed subframes in which the transmission direction is fixed in the cluster.

As described above, in the radio communication system 1 according to the present embodiment, the subset to use in a cluster is selected from a plurality of subsets that are determined based on the number of fixed subframes, and UL/DL configurations to match each cell's traffic are selected from a plurality of UL/DL configurations that are shown in this subset. By this means, it is possible to prevent the loss of traffic adaptation gain, while reducing the inter-cell interference in the cluster.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of the claims. Consequently, the descriptions herein are provided only for the purpose of explaining examples, and should by no means be construed to limit the present invention in any way. Also, each embodiment may be combined as appropriate and implemented.

The disclosure of Japanese Patent Application No. 2013-045804, filed on Mar. 7, 2013, including the specification, drawings and abstract, is incorporated herein by reference in its entirety.

1. A radio base station that communicates with a user terminal by using a UL/DL configuration, which represents a configuration of an uplink subframe and a downlink subframe in a radio frame, the radio base station comprising:
a subset selection section that selects a subset to use in a cluster, from a plurality of subsets, each of which includes a plurality of UL/DL configurations determined based on the number of fixed subframes in which a transmission direction is fixed in the cluster; and
a UL/DL configuration selection section that selects a UL/DL configuration to use to communicate with the user terminal, from a plurality of UL/DL configurations that are included in the selected subset.

2. The radio base station according to claim 1, wherein the subset selection section selects the subset based on interference information and/or traffic information in each radio base station.

3. The radio base station according to claim 1, further comprising a subset information reporting section that reports subset information, which represents the selected subset, to another radio base station in the cluster.

4. The radio base station according to claim 1, further comprising an assignment section that assigns a fixed subframe, and a dynamic subframe in which the transmission direction is not fixed in the cluster, in each radio base station based on the selected subset.

5. The radio base station according to claim 4, wherein, when a plurality of frequency/space resources are used in each radio base station, the assignment section assigns a restricted subframe, in which uplink/downlink transmission or uplink/downlink transmission power is controlled, instead of the dynamic subframe, to part of the frequency/space resources used in each radio base station, so as not to occur interference between each radio base station in the dynamic subframe.

6. The radio base station according to claim 4, further comprising an assignment information reporting section that reports the assignment information in the assignment section to another radio base station in the cluster.

7. The radio base station according to claim 1, further comprising a UL/DL configuration information reporting section that reports UL/DL configuration information, which represents the UL/DL configuration selected in the UL/DL configuration selection section, to the user terminal.

8. A user terminal that communicates with a radio base station by using a UL/DL configuration, which represents a configuration of an uplink subframe and a downlink subframe in a radio frame, the user terminal comprising:
a UL/DL configuration acquiring section that acquires UL/DL configuration information, which represents a UL/DL configuration selected in the radio base station from a plurality of UL/DL configurations that are included in a subset; and
a communication section that communicates with the radio base station by using the UL/DL configuration represented by the UL/DL configuration information,
wherein the subset is selected from a plurality of subsets, each of which includes a plurality of UL/DL configurations determined based on the number of fixed subframes in which a transmission direction is fixed in a cluster.

9. A radio communication system in which each radio base station in a cluster communicates with a user terminal by using a UL/DL configuration that represents a configuration of an uplink subframe and a downlink subframe in a radio frame, the radio communication system comprising:
a subset selection section that selects a subset to use in the cluster, from a plurality of subsets, each of which includes a plurality of UL/DL configurations determined based on the number of fixed subframes in which a transmission direction is fixed in the cluster; and
a UL/DL configuration selection section that selects a UL/DL configuration to use to communicate with the user terminal, from a plurality of UL/DL configurations that are included in the selected subset.

10. A radio communication method in which each radio base station in a cluster communicates with a user terminal by using a UL/DL configuration that represents a configuration of an uplink subframe and a downlink subframe in a radio frame, the radio communication method comprising the steps of:
selecting a subset to use in the cluster, from a plurality of subsets, each of which includes a plurality of UL/DL configurations determined based on the number of fixed subframes in which a transmission direction is fixed in the cluster; and
selecting a UL/DL configuration to use to communicate with the user terminal, from a plurality of UL/DL configurations that are included in the selected subset.

11. The radio base station according to claim 2, further comprising a subset information reporting section that reports subset information, which represents the selected subset, to another radio base station in the cluster.

12. The radio base station according to claim 5, further comprising an assignment information reporting section that reports the assignment information in the assignment section to another radio base station in the cluster.
